(19) United States
(12) Patent Application Publication
(10) Pub. No.: US 2015/0225615 A1
(43) Pub. Date: Aug. 13, 2015

(54) HEAT-INSULATION FILM FOR HIGH TEMPERATURE MOLDING, VACUUM THERMAL INSULATOR USING SAME AND PROCESS FOR FABRICATING VACUUM THERMAL INSULATOR

(71) Applicant: DO YOUNG H.S. CO., LTD, Busan (KR)

(72) Inventor: Jung Won Kim, Busan (KR)

(21) Appl. No.: 14/423,915

(22) PCT Filed: Jul. 12, 2013
(86) PCT No.: PCT/KR2013/006242

§ 371 Date: Feb. 25, 2015

(30) Foreign Application Priority Data
Oct. 17, 2012 (KR) 10-2012-0115333

(51) Int. Cl. C09J 7/02; B32B 27/08; B32B 37/06; B32B 37/18; B32B 38/00; B32B 37/10; B32B 15/092; B32B 27/36

(52) U.S. Cl. CPC C09J 7/0296; C09J 7/0242; B32B 15/092; B32B 27/08; B32B 27/36; B32B 37/18; B32B 37/182; B32B 38/0004; B32B 38/0012; B32B 37/1018; B32B 37/06; C09J 2463/00; C09J 2467/006; C09J 2400/163; C09J 2400/143; B32B 2255/06; B32B 2255/26; B32B 2262/101; B32B 2307/304; B32B 2305/022; B32B 2305/28; B32B 2315/02; B32B 2315/085; B32B 2375/00

(57) ABSTRACT

Disclosed are a heat-insulation film laminated with formability at a high temperature, a vacuum thermal insulator covered on an outer portion of a core material of the heat-insulation film, and a method of fabricating the vacuum thermal insulator in which the heat-insulation film is covered on the outer portion of the core material through the thermal-fusion process. The heat-insulation film is stably covered on the outer portion of the core material through the thermal-fusion process at the high temperature.

### TECHNICAL FIELD

The present invention relates to a heat-insulation film. More specifically, the present invention relates to a heat-insulation film that can be thermal-fusion formed, a vacuum thermal insulator including the heat-insulation film, and a method of fabricating the vacuum thermal insulator through the thermal-fusion process using the heat-insulation film.

### BACKGROUND ART

Recently, a vacuum thermal insulator has been extensively used instead of a conventional thermal insulator, such as polyurethane or styrofoam. Generally, the vacuum thermal insulator has a structure in which an outer portion of a core material is surrounded by a heat-insulation film representing low transmittance similar to that of gas or moisture and serving as an outer skin material. Since the vacuum thermal insulator represents a significantly excellent thermal insulation effect, the demand for the vacuum thermal insulator is recently increased.

The heat-insulation film generally used as the outer skin material of the vacuum thermal insulator has a structure in which films are laminated at several layers. Especially, the heat-insulation film has a lamination structure of complex plastic representing an excellent gas barrier property. A vacuum thermal insulator according to the related art is fabricated by receiving plastic foam or an inorganic material as a core material, decompressing an internal structure, and sealing an outer portion of the core material using the heat-insulation film through a high-frequency scheme. However, when the heat-insulation film is bonded to the outer portion of the core material through a vacuum high-frequency scheme, the heat-insulation film may not tightly make contact with the core material from, especially an edge portion of the core material in the process of covering the outer portion of the core material with the heat-insulation film. Accordingly, air or moisture passes through the heat-insulation film, so that the degree of vacuum is lowered according to the elapse of time. Accordingly, the insulating property of the heat-insulation film may not be maintained. Especially, the heat-insulation film may be deformed at high humidity.

In addition, when forming the surface and the edge portion of the core material in the process of sealing the heat-insulation film to manufacture the vacuum thermal insulator according to the related art, the heat-insulation film may be twisted, so that produce failure may occur.

### DISCLOSURE

### Technical Problem

The present invention is suggested to solve the problem of the related art, and an object of the present invention is to provide a heat-insulation film having excellent heat resistance and a vacuum thermal insulator having the heat-insulation film as an outer skin material thereof.

Another object of the present invention is to provide a method of fabricating a vacuum thermal insulator capable of facilitating processing and forming works by covering an outer portion of a core material with a heat-insulation film having excellent heat resistance through a thermal-fusion molding process.

### Technical Solution

In order to accomplish the above object of the present invention, there is provided a heat-insulation film including a first film layer including a material selected from the group consisting of polyethylene terephthalate (PET), polyethylene naphthalate (PEN), and polyimide (PI), a first barrier layer laminated on one surface of the first film layer through a first bonding layer including a material selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin, and a hot-melt layer laminated on an opposite surface of the first barrier layer and including a material selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin.

In this case, the heat-insulation film further may include a heat-insulation coating layer interposed between the first film layer and the first bonding layer and including glass fiber.

According to one embodiment, the heat-insulation film may have a complex heat-insulation film structure in which a second film layer including a material selected from the group consisting of polyethylene terephthalate (PET), polyethylene naphthalate (PEN), and polyimide (PI) is additionally laminated on the opposite surface of the first barrier layer through a second bonding layer, which includes a material selected from the group consisting of linear low density polyethylene (LLDPE), low density polyethylene (LDPE), high density polyethylene (HDPE), casted polypropylene (CPP), polyethylene, polyethylene terephthalate, polypropylene, ethylene vinyl acetate (EVA), epoxy resin, and phenol resin, while being interposed between the first barrier layer and the hot-melt layer.

According to another embodiment, a second barrier layer may be additionally laminated on an opposite surface of the second film layer through a third bonding layer, which includes a material selected from the group consisting of linear low density polyethylene (LLDPE), low density polyethylene (LDPE), high density polyethylene (HDPE), casted polypropylene (CPP), polyethylene, polyethylene terephthalate, polypropylene, ethylene vinyl acetate (EVA), epoxy resin, and phenol resin, while being interposed between the second film layer and the hot-melt layer.

In addition, there is provided a method of fabricating a vacuum thermal insulator, which includes cutting a core material, arranging the heat-insulation film at upper and lower portions of the core material to transfer the heat-insulation film to a vacuum forming device, the heat-insulation film serving as an outer skin material, forming an inner part of the vacuum forming device in a vacuum state, forming the vacuum thermal insulator by performing a thermal-fusion process for the outer skin material and the core material using a heating unit, and cutting an outer portion of the formed vacuum thermal insulator.

For example, the core material may include a material selected from the group consisting of ceramic paper, cerakwool, distillation silica, polyurethane foam, glass wool, aerogel, non-woven fabric, Techlon, and a rockwool board.

Meanwhile, the present invention provides a vacuum thermal insulator including a core material constituting a heat-insulation layer and the heat-insulation film, which serves as an outer skin material covered on an outer portion of the core material.

In this case, the core material may include a material selected from the group consisting of ceramic paper, cerakwool, distillation silica, polyurethane foam, glass wool, aerogel, non-woven fabric, Techlon, and a rockwool board.

### Advantageous Effects

As described above, the present invention suggests the heat-insulation film having excellent heat resistance and the vacuum thermal insulator configured by surrounding the outer portion of the core material using the heat-insulation film.

The heat-insulation film has excellent heat resistance. Accordingly, since the heat-insulation film can be covered on the outer portion of the core material through the thermal-fusion process. Accordingly, the processing work and the forming work can be easily performed. The forming work can be performed in the tight contact with the core material.

In particular, different from the related art, the heat-insulation film is simultaneously and completely covered on the outer portion of the core material while tightly making contact with the outer portion of the core material, so that air or moisture may not penetrate through the heat-insulation film. Accordingly, a higher vacuum state can be maintained. Especially, the deformation of the heat-insulation film can be prevented even at higher humidity. Accordingly, the vacuum state can be maintained and the heat-insulation performance can be continuously maintained.

In addition, the heat-insulation film can be smoothly covered on the surface of the core material through the thermal-fusion process. In addition, the heat-insulation film can be prevented from being twisted at the edge region, so that the failure rate can be reduced.

### DESCRIPTION OF DRAWINGS

FIG. 1 is a sectional view schematically showing the lamination structure of a heat-insulation film according to a first embodiment of the present invention.

FIG. 2 is a sectional view schematically showing the lamination structure of a heat-insulation film according to a second embodiment of the present invention.

FIG. 3 is a sectional view schematically showing the lamination structure of a heat-insulation film according to a third embodiment of the present invention.

FIG. 4 is a sectional view schematically showing the lamination structure of a heat-insulation film according to a fourth embodiment of the present invention.

FIG. 5 is a flowchart schematically showing a process of fabricating a vacuum thermal insulator through a thermal-fusion process using a heat-insulation film fabricated according to the present invention.

FIG. 6 is a schematic view showing a vacuum forming device to perform a thermal-fusion process in a vacuum state according to the present invention.

FIGS. 7a to 7c are sectional views schematically showing a process of fabricating a vacuum thermal insulator having a structure in which a heat-insulation film according to the present invention is covered on an outer portion of the core material through the thermal-fusion process.

FIGS. 8a to 8e are photographs showing the states of the vacuum thermal insulator fabricated according to the present invention, respectively.

### BEST MODE

### Mode for Invention

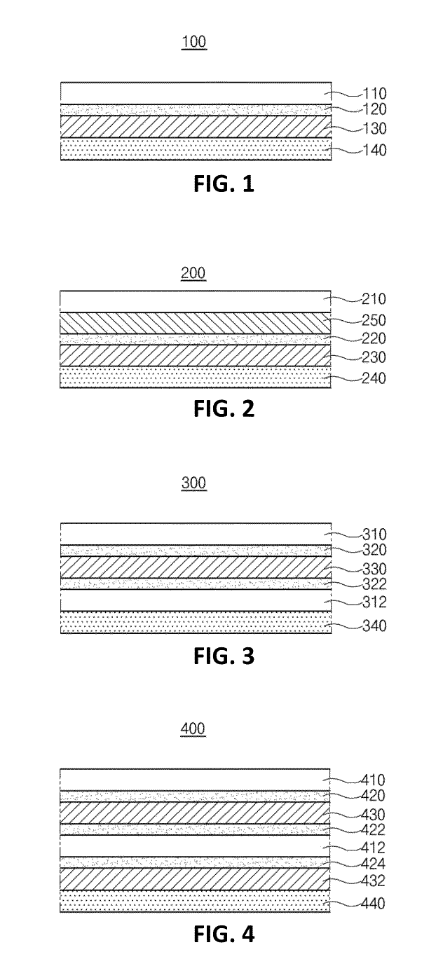

The present inventors make the present invention based on an idea that it is preferred that a heat-insulation film is bonded to an outer portion of a core material through a thermal-fusion scheme of a hot melt scheme in order to solve a problem occurring in the related art. Hereinafter, the present invention will be described in more detail with reference to accompanying drawings. FIG. 1 is a sectional view schematically showing the lamination structure of a heat-insulation film according to a first embodiment of the present invention. As shown in FIG. 1, a heat-insulation film 100 according to a first embodiment of the present invention includes a first film layer 110 formed of polymer resin, a first bonding layer 120 bonded to one surface of the first film layer 110, a first barrier layer 130 laminated on one surface of the first bonding layer 120, and a hot-melt layer 140 attached to one surface of the first barrier layer 130.

The heat-insulation film 100 according to the first embodiment is configured to employ a thermal-fusion scheme in a process of covering the heat-insulation film 100 on an outer portion of a core material using a material maintaining a basic physical property at a high temperature, for example the temperature of 120° C. to 250° C., preferably, 200° C. to 250° C. For example, polymer resin having a high glass transition temperature may be used for the first film layer 110, the first bonding layer 120, and the hot-melt layer 140. In detail, the first film layer 110, which protects a surface or the core material bonded to an inner part of the heat-insulation film 100 from external impact, is formed of polymer resin having excellent impact resistance or maintaining a physical property thereof at a high temperature. For example, the first film layer 110 may include polymer resin selected from the group consisting of polyethylene terephthalate (PET), polyethylene naphthalate (PEN), and polyimide (PI). Preferably, the first film layer 110 may have the thickness in the range of 4 μm to 350 μm. If the thickness of the first film layer 110 is less than a value in the above range, the first film layer 110 may be damaged due to external impact or scratch. If the thickness of the first film layer 110 exceeds the value in the above range, when a vacuum thermal insulator to be described below is fabricated, a problem may occur. For example, regarding the polymer resin constituting the first film layer 110, polyethylene terephthalate (PET), such as “Skynex® NXIO(SKC)”, “Skynex® TKIO(SKC)”, “Skynex® TK20(SKC)”, or “Skynex® TK50(SKC)” and polyimide (PI) such as IF70 (SKC) may be used.

However, the present invention is not limited thereto, but the first film layer 110 may include various materials.

Meanwhile, the first bonding layer 120 bonded to one surface of the first film layer 110 may include polymer resin selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin such as modified epoxy resin, and phenol resin such as modified phenol resin. The first bonding layer 120 may be bonded to the first film layer 110 at the thickness of 1 μm to 100 μm.

Meanwhile, the first barrier layer 130 laminated on the first bonding layer 120 in opposition to the first film layer 110 serves as a gas barrier layer. The first barrier layer 130 may include an aluminum foil, preferably an inorganic material such as aluminum, alumina, or silicon. Preferably, the first barrier layer 130 is laminated at the thickness of 5 μm to 100 μm.

Meanwhile, the hot-melt layer 140, which is laminated on one surface of the first barrier layer 130 to tightly make contact with the outer surface of the core material in the process of covering the outer portion of the core material with the heat-insulation film 100, may include polymer resin having an excellent sealing property. For example, the hot-melt layer 140 include polymer resin selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin. For example, the hot-melt layer 140 may be laminated at a thickness in the range of 1 μm to 100 μm, preferably the thickness in the range of 3 μm to 100 μm. If the thickness of the hot-melt layer 140 is less than a value in the above range, the hot-melt layer 140 may not tightly make contact with the core material. If the thickness of the hot-melt layer 140 exceeds the value in the above range, the durability of a vacuum thermal insulator finally fabricated may be degraded. In the case of a conventional heat-insulation film used for the vacuum thermal insulator, a high-frequency bonding scheme is employed. The heat-insulation film according to the present invention including the heat-insulation film 100 according to the first embodiment forms the hot-melt layer 140, so that the heat-insulation film can be stably and rapidly covered on the outer portion of the core material.

According to the first embodiment of the present invention, the first bonding layer 120 and the hot-melt layer 140 may include polymer resin selected from the group consisting of linear low density polyethylene (LLDPE), low density polyethylene (LDPE), high density polyethylene (HDPE), casted polypropylene (CPP), polyethylene (PE), polyethylene, polyethylene terephthalate (PET), polypropylene (PP), ethylene vinyl acetate (EVA), epoxy resin, and phenol resin representing an excellent physical property such as impact strength and flexibility. Therefore, not only can the heat resistance of the heat-insulation film 100 be improved, but also the durability of the vacuum thermal insulator produced by covering the heat-insulation film 100 onto the outer portion of the core material through the thermal-fusion process can be improved, thereby preventing the heat-insulation film 100 from being damaged by external impact.

The heat-insulation film 100 according to the first embodiment can be covered on the outer portion of the core material while maintaining the basic physical property thereof even through the high-temperature thermal fusing forming process, so that the heat-insulation film 100 can be utilized for the vacuum thermal insulator. However, in order to accomplish a more excellent insulating effect, components may be further provided. FIG. 2 is a sectional view schematically showing the lamination structure of a heat-insulation film according to the second embodiment of the present invention. In the structure of a heat-insulation film 200 shown in FIG. 2, since a first film layer 210, a first bonding layer 220, a first barrier layer 230, and a hot-melt layer 240 are the same as those described with reference to FIG. 1, the details thereof will be omitted. The heat-insulation film 200 shown in FIG. 2 further includes a heat-insulation coating layer 250 interposed between the first film layer 210 and the first bonding layer 220 and formed of a heat-insulation material such as glass fiber to more maximize the heat-insulation effect. The heat-insulation coating layer 250 may have various thicknesses sufficient to provide a heat-insulation effect to the heat-insulation film 200. For example, the heat-insulation coating layer 250 may be formed at the thickness of 1 μm to 100 μm.

Meanwhile, although FIGS. 1 and 2 show that a heat-insulation film including one film layer, a complex heat-insulation film including at least two film layers if necessary may be taken into consideration. FIG. 3 is a sectional view schematically showing the lamination structure of the heat-insulation film according to a third embodiment. In the structure of a heat-insulation film 300 shown in FIG. 3, since a first film layer 310, a first bonding layer 320, a first barrier layer 330, and a hot-melt layer 340 are the same as those described in the first embodiment, the details thereof will be omitted.

In the heat-insulation film 300 according to the third embodiment, a second film layer 312 is interposed between the first barrier layer 330 and the hot-melt layer 340 through a second bonding layer 322. In this case, the second bonding layer 322 may include linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, or phenol resin. The second bonding layer 322 may be provided at a thickness substantially equal to that of the first bonding layer 320 and interposed between the first barrier layer 330 and the second film layer 312. Meanwhile, the second film layer 312 may include a material selected from the group consisting of PET, PEN, and PI. For example, the second film layer 312 may be laminated at the thickness in the range of 4 μm to 350 μm.

According to the third embodiment described above, two film layers are provided to maximize the heat-insulation effect. The present invention is not limited to a complex heat-insulation film including two film layers, but the complex insulation film may include at least three film layers. In addition, similarly to the second embodiment, a heat-insulation coating layer formed of glass fiber may be additionally interposed between the first film layer 310 and the first bonding layer 320 and/or between the second film layer 312 and the second bonding layer 322. Meanwhile, a complex insulating film having a multi-layer structure including at least two barrier layers may be taken into consideration in addition to the formation of at least two polymer resin film layers. FIG. 4 is a sectional view schematically showing the lamination structure of a heat-insulation film according to the fourth embodiment of the present invention. When comparing with the third embodiment, since a first film layer 410, a first bonding layer 420, a first barrier layer 430, a second bonding layer 422, a second film layer 412, and a hot-melt layer 440 have the same structure as that of the third embodiment, the details thereof will be omitted. In a complex heat-insulation film 400 having the multi-structure according to the present embodiment, a second barrier layer 432 is additionally interposed between the second film layer 412 and the hot-melt layer 440 through the third bonding layer 424. In this case, the third bonding layer 424 includes a material selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin and is interposed between the second film layer 412 and the second barrier layer 432. The third bonding layer 424 may be interposed at the thickness equal to those of the first bonding layer 420 and the second bonding layer 422. Meanwhile, the second barrier layer 432 may serve as a gas-barrier layer similarly to the first barrier layer 430, and may be laminated at the thickness in the range of 5 μm to 100 μm.

According to the fourth embodiment described above, two film layers are provided to maximize the heat-insulation effect. The present invention is not limited to a complex heat-insulation film including two film layers, but the complex insulation film may include at least three film layers including polymer resin and at least three barrier layers. In addition, similarly to the second embodiment, a heat-insulation coating layer formed of glass fiber may be interposed between the first film layer 410 and the first bonding layer 420 and/or between the second film layer 412 and the second bonding layer 422.

As described in the third and fourth embodiments, if a complex heat-insulation film having a multi-layer structure in which at least two film layers and/or at least two barrier layers are laminated is used, excellent heat resistance can be acquired, and tensile force and the heat-insulation effect can be enhanced to maximize flame resistance. Accordingly, the complex heat-insulation film can be utilized for heat-insulation necessary for a special application field, for example a pipe and a turbine of nuclear power generation, hydroelectric power generation, and thermoelectric power generation, and other industrial fields.

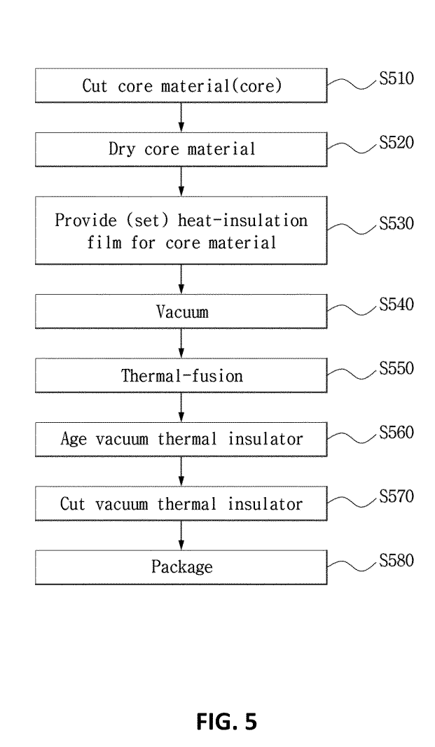

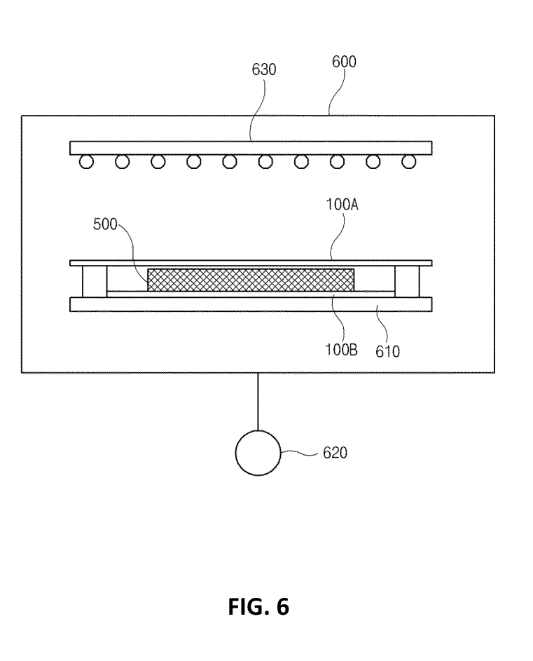

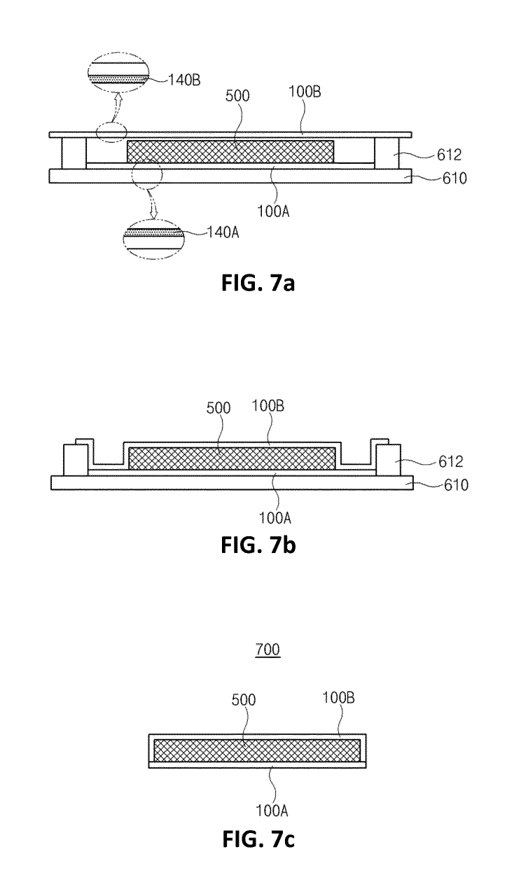

Subsequently, a process of fabricating the vacuum thermal insulator by covering the heat-insulation film onto the outer portion of the core material according to the present invention will be described. Although description will be made regarding the heat-insulation film 100 according to the first embodiment among the above-described heat-insulation films, other heat-insulation films may be covered onto the outer portion of the core material through the same process. FIG. 5 is a flowchart schematically showing a process of fabricating the vacuum thermal insulator through the thermal-fusion process using the heat-insulation film fabricated according to the present invention. FIG. 6 is a schematic view showing a vacuum forming device to perform the thermal-fusion process in a vacuum state according to the present invention. FIGS. 7a to 7c are sectional views schematically showing a process of fabricating the vacuum thermal insulator having a structure in which the heat-insulation film according to the present invention is covered on an outer portion of the core material through the thermal-fusion process. First, a core material is cut in a desirable size using a cutting unit, and a cutting surface is primarily machined so that the cutting surface is smoothly made (S510). The primarily machined core material 500 is introduced into a drying furnace to dry the core material 500, so that moisture can be completely removed from the core material 500 (S520). The cutting unit to cut the core material 500 in the desirable size may include a typical saw blade or water-jet using water.

The core material 500, which may be used in the present invention, may be a certain core material used in fabricating a conventional vacuum thermal insulator. For example, the core material 500 may include one selected from the group consisting of ceramic paper, cerakwool, distillation silica, polyurethane foam, glass wool, aerogel, non-woven fabric, Techlon, and a rockwool board. Preferably, if nonflammable materials, such as ceramic paper, cerakwool, aerogel, Techlon, and a rockwool board, are used, safety from fire can be ensured, and the material includes ingredients that are not harmful to the human body to satisfy the eco-friendly trend.

The core material 500 subject to the drying process and heat-insulation films 100A and 100B, which are additionally prepared, are transferred into a vacuum forming device 600 through a transfer unit such as a conveyer belt in the state that the above materials are arranged above a forming die (forming tray 610) (S530). As shown in FIG. 6, after the first heat-insulation film 100A is first provided on the forming die 610, and the core material 500 is provided on the first heat-insulation film 100A, the second heat-insulation film 100B is provided on the core material 500. In this state, the materials may be transferred into the vacuum forming device 600. In this case, the heat-insulation films 100A and 100B may be covered on the outer portion of the core material 500 through hot-melt layers of the heat-insulation films 100A and 100B. To this end, as shown in FIG. 7a, the first heat-insulation film 100A is provided in such a manner that a first hot-melt layer 140A is positioned on the first heat-insulation film 100A provided under the core material 500, and the second heat-insulation film 100B is provided in such a manner that a second hot-melt layer 140B is positioned under the second heat-insulation film 100B.

In the process of providing the heat-insulation films 100A and 100B and the core material 500, the first and second heat-insulation films 100A and 100B extend in a longitudinal direction with a length longer than that of the core material 500. Accordingly, in the thermal-fusion process, an outer lateral side of the core material 500 can be surrounded by the first and second heat-insulation films 100A and 100B in addition to the top surface and the bottom surface of the core material 500. For example, the first heat-insulation film 100A is provided inside a forming frame 612 protruding upward from the edge of the forming die 610, and the edge of the second heat-insulation film 100B may be supported by the forming frame 612.

In the above arrangement state, an inner part of the vacuum forming device 600 having the core material 500 and the heat-insulation films 100A and 100B arranged therein is made in a vacuum state using a vacuum pump 620 coupled to the vacuum forming device 600 (S540). In order to form a vacuum heat-insulation material, the vacuum state may be about 10⁻⁴ Torr or less (about 0.01 Pa or less). The vacuum pump 620 to make the high-vacuum state may include a rotary pump, a booster pump, and a diffusion pump. Thereafter, heat is applied to the inner part of the vacuum forming device 600 using a heating unit 630 provided in the vacuum forming device 600 to perform a thermal-fusion process so that the heat-insulation films 100A and 100B are covered on the outer portion of the core material 500 (S550). The temperature of the heating unit 630 may be adjusted to the temperature in the range of 180° C. to 250° C. The heat-insulation films 100A and 100B are covered on the outer portion of the core material 500 through the thermal-fusion process by heat supplied from the heating unit 630. In other words, as shown in FIG. 7b, the hot-melt layers 140A and 140B tightly making contact with the core material 500 in the heat-insulation films 140A and 140B provided under and on the core material 500, respectively, are contracted and melt so that the top surface and the bottom surface of the core material 500 and both lateral sides of the core material 500 are covered with the heat-insulation films 100A and 100B, thereby forming the vacuum thermal insulator. For example, the heating unit 630 may include a hot wire, but the present invention is not limited thereto.

A conventional heat-insulation film used for a vacuum thermal insulator is covered on the outer portion of the core material through a high-frequency scheme after vacuum, so that a problem may occur in the adhesive strength with the core material. However, according to the present invention, since the heat-insulation film is bonded to the core material through the thermal-fusion process, the adhesive strength and the adhesive maintain capability can be improved, so that a significantly excellent vacuum state can be maintained. In addition, excellent performance can be maintained in preventing a film from being deformed by moisture.

The vacuum thermal insulator primarily processed after the thermal-fusion process is aged for a predetermined time until the vacuum thermal insulator is cooled so that the heat-insulation films 100A and 100B are completely bonded to the core material 500 (S570). The formed vacuum thermal insulator is withdrawn out of the vacuum forming device 600 and a forming frame 620. Thereafter, an outer edge of the vacuum thermal insulator is cut using a cutting unit such as a blade. Accordingly, as shown in FIG. 7c, the vacuum thermal insulator 700, which is formed by covering the heat-insulation films 100A and 100B on the outer portion of the core material 500, may be completed. When forming a vacuum thermal insulator according to a conventional scheme, in the process of covering and cutting a heat-insulation film covered on the outer portion of the core material, especially the process of forming an edge portion of a produce, the film may be twisted so that the failure rate may be increased. According to the present invention employing the thermal-fusion scheme, when the heat-insulation film is cut, the cutting surface of the heat-insulation film can be smoothly processed, and the twisting of the edge portion is removed, so that the failure rate may be significantly reduced. Vacuum thermal insulators subject to the final cutting are packaged according to sizes in a box (S580), thereby completing the fabrication process of the vacuum insulator.

Although the present invention will be described below using exemplar embodiments, the preset invention is not limited thereto.

### EMBODIMENT 1

### Fabrication of Heat-Insulation Film

An epoxy resin hot-melt adhesive agent was applied on a bottom surface of a first film layer formed at the thickness of 25 μm and formed of polyethylene terephthalate (SKC, Skynex®, or NX10) by a laminating machine, thereby forming a first adhesive layer having the thickness of 5 μm. A first barrier layer including an aluminum foil was laminated at the thickness of 15 μm on the bottom surface of the first film layer by the laminating machine, and a modified epoxy resin hot-melt adhesive was applied at the thickness of 20 μm on the first barrier layer.

### EMBODIMENT 2

### Fabrication of Heat-Insulation Film

A heat-insulation film according to the second embodiment was fabricated by repeating the procedure of the first embodiment except that a glass fiber having the thickness of 20 μm was interposed between a first film layer and a first bonding layer.

### EMBODIMENT 3

### Fabrication of Heat-Insulation Film

A heat-insulation film according to the third embodiment was fabricated by repeating the procedure of the first embodiment except that an epoxy resin hot-melt adhesive was applied between a first barrier layer and a holt-melt layer to form a second adhesive layer having the thickness of 15 μm, and a second film layer formed at the thickness of 100 μm and formed of polyethylene terephthalate (SKC, Skynex®, or NX10) was additionally formed.

### EMBODIMENT 4

### Fabrication of Heat-Insulation Film

A heat-insulation film according to the fourth embodiment was fabricated by repeating the procedure of the third embodiment except that an epoxy resin hot-melt adhesive was applied between a second barrier layer and a holt-melt layer to form a third adhesive layer having the thickness of 15 μm, and a second barrier layer having the thickness of 30 μm was further laminated.

### EMBODIMENT 5

### Fabrication of Heat-Insulation Film

The heat-insulation films fabricated according to the first to fourth embodiments described above were used as outer skin materials, and ceramic paper was used as a core material to fabricate the vacuum thermal insulator. The core material is cut in the size of 270 mm×270 mm, and the heat-insulation film and the core material were provided in a forming frame and set in a vacuum forming device. After the internal pressure of the vacuum forming device was adjusted to 10⁻⁴ torr, the temperature of the hot wire and the heating time were adjusted to various values, thereby performing the thermal-fusion process. After the thermal-fusion process was completed and the formed vacuum thermal insulator was aged, the bonding state between the heat-insulation film and the core material, the surface state, and the thickness variation were measured. The following table 1 shows the thermal-fusion temperature and the heating time of the vacuum thermal insulator, and the following table 2 shows a physical property test result.

TABLE 1

| | Temperature | Transmission | Heating | Core |
|---|---|---|---|---|
| Embodiment | of hot wire | temperature | time (Sec) | material |
| 3 | 193 | 105 | 3 | Ceramic paper |
| 1 | 193 | 105 | 3 | Ceramic paper |
| 2 | 193 | 105 | 3 | Ceramic paper |
| 3 | 193 | 105 | 3 | Ceramic paper |
| 4 | 193 | 105 | 3 | Ceramic paper |

TABLE 2

| | Bonding state | | Surface state | | Thickness change | |
|---|---|---|---|---|---|---|
| | Front | Rear | Front | Rear | Before | After |
| Embodiment | surface | surface | surface | surface | forming | forming |
| 3 | ◯ | ◯ | Good | Good | 5Tx4 | 9T |
| 1 | ◯ | ◯ | Good | Good | 5Tx2 | 4.5T |
| 2 | ◯ | ◯ | Good | Good | 5Tx2 | 4.5T |
| 3 | ◯ | ◯ | Good | Good | 5Tx2 | 4.5T |
| 4 | ◯ | ◯ | Good | Good | 5Tx2 | 4.5T |

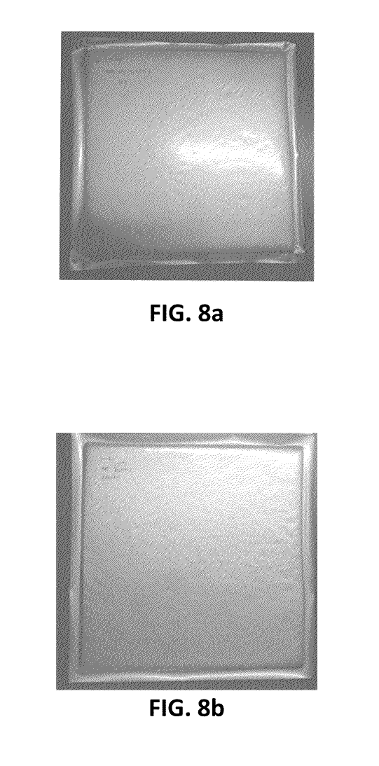

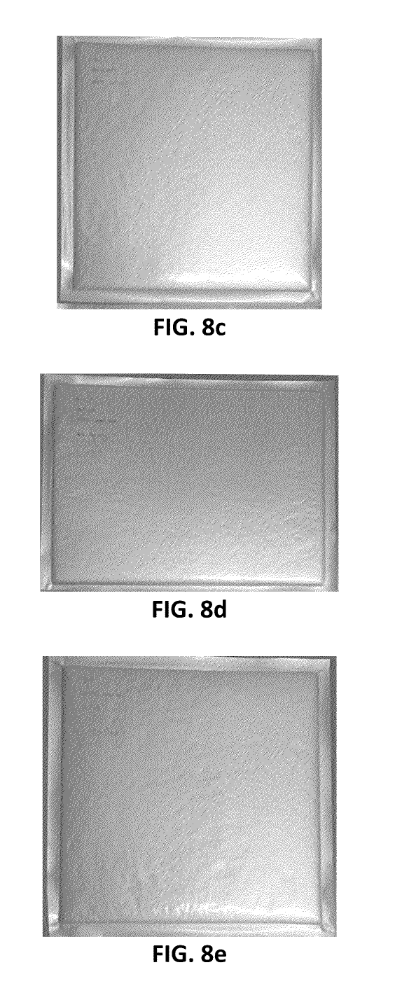

In addition, FIGS. 8a to 8e show the shapes of the vacuum thermal insulators fabricated according to the present embodiments, respectively. The core material was excellently bonded to the heat-insulation film, and the corner and the edge region were smoothly cut.

1. A heat-insulation film comprising:
a first film layer comprising a material selected from the group consisting of polyethylene terephthalate (PET), polyethylene naphthalate (PEN), and polyimide (PI);
a first barrier layer laminated on one surface of the first film layer through a first bonding layer comprising a material selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin; and
a hot-melt layer laminated on an opposite surface of the first barrier layer and comprising a material selected from the group consisting of linear low density polyethylene (LLDPE), low density polyethylene (LDPE), high density polyethylene (HDPE), casted polypropylene (CPP), polyethylene, polyethylene terephthalate (PET), polypropylene (PP), ethylene vinyl acetate (EVA), epoxy resin, and phenol resin.

2. The heat-insulation film of claim 1, further comprising a heat-insulation coating layer interposed between the first film layer and the first bonding layer and comprising glass fiber.

3. The heat-insulation film of claim 1, further comprising a second film layer comprising a material selected from the group consisting of polyethylene terephthalate (PET), polyethylene naphthalate (PEN), and polyimide (PI) and additionally laminated on the opposite surface of the first barrier layer through a second bonding layer, which comprises a material selected from the group consisting of linear low density polyethylene (LLDPE), low density polyethylene (LDPE), high density polyethylene (HDPE), casted polypropylene (CPP), polyethylene, polyethylene terephthalate, polypropylene, ethylene vinyl acetate (EVA), epoxy resin, and phenol resin, while being interposed between the first barrier layer and the hot-melt layer.

4. The heat-insulation film of claim 3, further comprising a second barrier layer additionally laminated on an opposite surface of the second film layer through a third bonding layer, which comprises a material selected from the group consisting of linear low density polyethylene (LLDPE), low density polyethylene (LDPE), high density polyethylene (HDPE), casted polypropylene (CPP), polyethylene, polyethylene terephthalate, polypropylene, ethylene vinyl acetate (EVA), epoxy resin, and phenol resin, while being interposed between the second film layer and the hot-melt layer.

5. A method of fabricating a vacuum thermal insulator, the method comprising:
cutting a core material;
arranging a heat-insulation film according to claim 1 at upper and lower portions of the core material to transfer the heat-insulation film to a vacuum forming device, the heat-insulation film serving as an outer skin material;
forming an inner part of the vacuum forming device in a vacuum state;
forming the vacuum thermal insulator by performing a thermal-fusion process for the outer skin material and the core material using a heating unit; and
cutting an outer portion of the formed vacuum thermal insulator.

6. The method of claim 5, wherein the core material comprises a material selected from the group consisting of ceramic paper, cerakwool, distillation silica, polyurethane foam, glass wool, aerogel, non-woven fabric, Techlon, and a rockwool board.

7. A vacuum thermal insulator comprising a core material constituting a heat-insulation layer and a heat-insulation film according to claim 1, which serves as an outer skin material covered on an outer portion of the core material.

8. The vacuum thermal insulator of claim 7, wherein the core material comprises a material selected from the group consisting of ceramic paper, cerakwool, distillation silica, polyurethane foam, glass wool, aerogel, non-woven fabric, Techlon, and a rockwool board.

9. A vacuum thermal insulator comprising a core material constituting a heat-insulation layer and a heat-insulation film according to claim 2, which serves as an outer skin material covered on an outer portion of the core material.

10. A vacuum thermal insulator comprising a core material constituting a heat-insulation layer and a heat-insulation film according to claim 3, which serves as an outer skin material covered on an outer portion of the core material.

11. A vacuum thermal insulator comprising a core material constituting a heat-insulation layer and a heat-insulation film according to claim 4, which serves as an outer skin material covered on an outer portion of the core material.
